(19) United States
(12) Patent Application Publication
(10) Pub. No.: US 2003/0120744 A1
(43) Pub. Date: Jun. 26, 2003

(54) Method and apparatus for providing downlaoded audio data

(76) Inventor: Gordon Kessler, Mt. Kisco, NY (US)

Correspondence Address: Gordon Kessler, 59 Fox Den Road, Mt. Kisco, NY, 10549, US

(21) Appl. No.: 10/028,516

(22) Filed: Dec. 20, 2001

(51) Int. Cl. G06F 15/16

(52) U.S. Cl. 709/217

(57) ABSTRACT

A method, apparatus and system for downloading audio data. The method comprises the steps of providing user preference data indicating one or more topics of interest to a user, and a relative ranking between these topics and providing user designated time span data indicative of a desired time for listening to an audio program. This user preference data and user designated time span data are then forwarded to a storage device and a plurality of audio data corresponding to the user preference data is retrieved. A length of time required to playback the audio data is first determined, and then it is determined whether the length of time required to playback the audio data is longer than the user designated time span. If it is determined that the length of time required to playback the audio data is longer than the user designated time span, then the length of at least one of the plurality of audio data is reduced. Finally, the audio data including the one of the plurality of audio data reduced in length is output.

### BACKGROUND OF THE INVENTION

This invention relates generally to the downloading of audio information from a base device to a remote device, and more particularly to the determination of such information to be downloaded.

### SUMMARY OF THE INVENTION

The downloading of audio information from a computer to a portable device is well known. However, typically a user must designate the information to be downloaded. This requirement may be acceptable when a user is downloading a fixed amount of data, such as a predetermined amount of music or the like. However, this is not the only type of data that a user might want to download.

In accordance with the invention various news or other audio data are downloaded from a remote storage device to a base unit, and in turn if desired to a remote device. A user first indicates the various news or other topics he or she wishes to receive information about. The user also rates the importance of each of these types of information on a relative scale, an absolute scale, or by indicating whether the user prefers to receive extended, summary or only title information about a particular topic. After designation of the various topics and the importance thereof, the user then indicates the amount of time he or she wishes the audio data to take up upon playback. This may correspond to the time for a user's commute, or any other desired time span.

After such a designation, the base unit retrieves the designated news topics from the remote storage device and determines the amount of data therein, and in turn the amount of time the data would take to play back in an audio mode. If this time is greater than the designated amount of time, then the base unit determines any number of the news or other programs to be provided only in summary or title form, based upon the designated user preferences. This process continues until the audio playback time is approximately equal to the user indicated time span. If after retrieval of the designated news topics it is determined that the audio playback of the audio data would not fill the entire user designated time frame, the base unit may download additional related information that may be of interest to the user, but does not comprise one of the designated news topics. Of course, the data download may be performed any number of times, for example once per day, without re-designating information. The designated information is used each time, thereby generating a personal newscast tailored the interests of the user, and presents this information to the user in a time span that is also acceptable to the user. The data may be transferred to the base unit as textual data and converted to audio data at the base unit. Alternatively, the data may be converted to audio data at the remote storage device and received as audio data at the base unit, preferably already tailored to fill the desired time span

While news programs are discussed above, any type of audio data may be employed. Furthermore, while audio data is discussed above, no audio data need be employed. Rather, the same invention may be employed to select a desired amount of data that is to be read by a user. In this manner, the remote device comprises a text display device. To determine the amount of time that might be required to read a particular amount of text, an average reading speed may be employed. If a user consistently reads faster or slower than the average, the user can designate that more or less textual information be provided, as appropriate.

Furthermore, the data need not be downloaded to a remote device. Rather, the data might be downloaded to a storage device at the base unit. This might be a fixed storage device and allow the user to listen to or read the data directly therefrom, such as in a laptop computer, palm computer or MP3 player. Alternatively, this storage device might be a removable storage device, such as a compact disc. The data stored thereon could therefore be retrieved using a car stereo, personal stereo or the like. The removable storage device may also comprise compact or flash memory for use in various appropriate devices. Additionally, data transfer may take place directly from the remote storage unit to the remote device during a designated data download period, or in real time via wireless, wired radio, or other appropriate communication method.

It is therefore an object of the invention to provide an improved data download method and apparatus that overcome the drawbacks of the prior art.

Still other objects and advantages of the invention will in part be obvious and will in part be apparent from the specification and the drawings.

The invention accordingly comprises the several steps and the relation of one or more of such steps with respect to each of the others, and the apparatus embodying features of the construction, combinations of elements and arrangement of parts that are adapted to effect such steps, all as exemplified in the following detailed disclosure, and the scope of the invention will be indicated in the claims.

### BRIEF DESRIPTION OF THE DRAWINGS

For a more complete understanding of the invention, reference is made to the following description and accompanying drawings, in which:

FIG. 1 is a block diagram depicting an example of a data download apparatus constructed in accordance with an embodiment of the invention;

FIG. 2 is a flowchart diagram depicting an example of a user data input sequence in accordance with the embodiment of the invention shown in FIG. 1;

FIG. 3 is a flowchart diagram depicting an example of a system operation sequence in accordance with the embodiment of the invention shown in FIG. 1;

FIG. 4 is a block diagram depicting an example of a data download apparatus constructed in accordance with an alternative embodiment of the invention;

FIG. 5 is a flowchart diagram depicting an example of a user data input sequence in accordance with the embodiment of the invention shown in FIG. 4;

FIG. 6 is a flowchart diagram depicting an example of a system operation sequence in accordance with the embodiment of the invention shown in FIG. 4;

FIG. 7 is a block diagram depicting an example of a data download apparatus constructed in accordance with another alternative embodiment of the invention;

FIG. 8 is a flowchart diagram depicting an example of a user data input sequence in accordance with the embodiment of the invention shown in FIG. 7;

FIG. 9 is a flowchart diagram depicting an example of a system operation sequence in accordance with the embodiment of the invention shown in FIG. 7;

FIG. 10 is a flowchart diagram depicting an example of a sequence for summarizing certain of retrieved audio data in accordance with an embodiment of the invention;

FIG. 11 is a flowchart diagram depicting an alternative example of a subsequence depicting the actual summarization method employed in the sequence of FIG. 10;

FIG. 12 is a flowchart diagram depicting another alternative example of a subsequence depicting the actual summarization method employed in the sequence of FIG. 10;

FIG. 13 is a flowchart diagram depicting yet another alternative example of a subsequence depicting the actual summarization method employed in the sequence of FIG. 10;

### DETAILED DESCRIPTION OF THE PREFERRED EMBODIMENTS

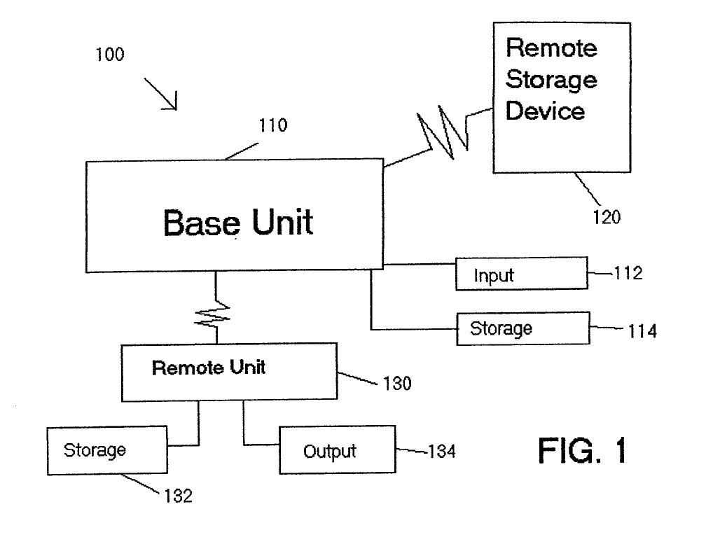

Referring first to FIG. 1, a data download system 100 constructed in accordance with the invention is shown. Data download system 100 comprises a base unit 110, a remote storage device 120 and a remote unit 130. Base unit 110 is preferably in contact with remote storage device 120 via the Internet or other computer network (such as a wide area network, local area network, Intranet, direct phone connection, wireless connection or the like), or via any other communication method, such as direct wired, wireless, radio or the like. Base unit 110 is also in contact with remote unit 130 by a direct connection, or through an appropriate bus (such as a universal serial bus, serial or parallel port) but may also be connected using any method similar to that used for connecting base unit 110 and remote storage device 120.

Base unit 110 is preferably provided as a personal computer but may comprise any appropriate computing device. Base unit 110 further comprises an input unit 112 to receive various input preferences from a user and a storage device 114 for storing various received data. Base unit 110 further comprises a CPU, display device and the like (not shown) common to a personal computer or other computing device. Remote storage device 120 comprises a storage memory, and also preferably comprises additional hardware common to a server device or personal computer (not shown). Remote unit 130 comprises a storage unit 132 for storing various received data and an output port 134 for outputting stored data. This remote unit might comprise any electronic device adapted to receive data, and output audio data, such as a radio receiver, any type of personal stereo, cellular telephone or the like. Output port 134 may allow for the coupling of an audio transducer, such as included with headphones or speakers, to remote unit 130 so that output stored data is converted to audio data. Alternatively, the stored data might be output in electronic form and acted upon at a further remote location.

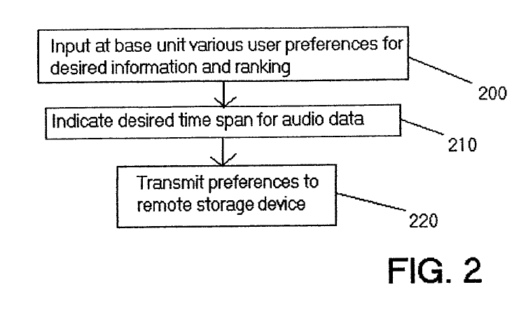

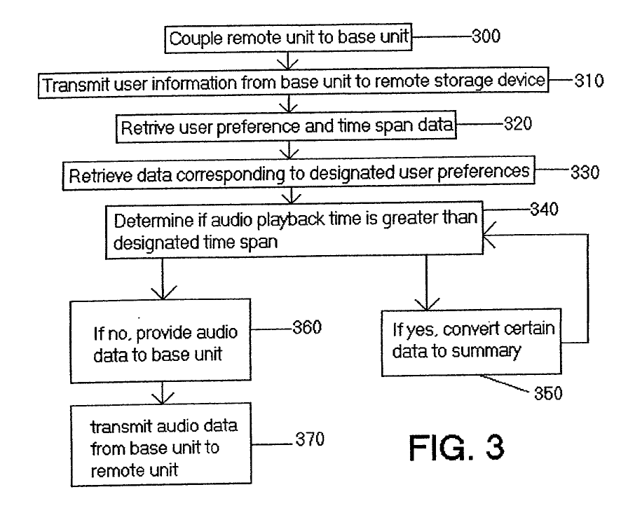

Referring next to FIGS. 2 and 3 in addition to FIG. 1, a preferred mode of operation will now be described. FIG. 2 depicts a sequence used to allow a user to designate various preferences. At a step 200 a user inputs various user preferences for desired information, and ranks these various preferences. This ranking may comprise designating most to least desirable information or simply indicating high or low priority for one or more of the desired information. Either way, based upon the user input, user preference data is generated indicating a relative preference for various types of desired data. After such preference input, control passes to step 210 where a user inputs a desired time span he or she wishes the output of the audio data to cover. This time span might correspond to a typical commute time for the user, but may correspond to any desired time span. Control then passes to step 230 where the input preference and time span data are transferred to the remote storage unit where this data is associated with a particular user and is stored in an appropriate database.

FIG. 3 depicts a sequence used when the audio data is to be downloaded to remote device 130. As is shown in FIG. 3, a remote device is first coupled to the base unit at step 300. This coupling is preferably performed via a wired connection such as through a direct serial connection, a bus such as a universal serial bus, a 1394 “firewire” bus or via any other network structure. This connection may further be performed via a wireless connection, via radio or via the Internet or other wide area network connection. Upon this connection the remote unit is identified to the base unit through various handshake protocols, as is well known in the art. Of course, rather than automatically identifying the remote device to the base unit, the user could enter a desired identification code so that the user preference could be used to retrieve data for a plurality of devices.

After the remote device has been identified to the base unit, this identification information accompanies an information request sent from the base unit to the remote storage device, as is shown at step 310. This identification information is then received by the remote storage device, and is used thereby to retrieve the user preferences and time span data associated with the transmitted identification information. Based upon these retrieved user preferences, in step 330 various news information data corresponding to these user preferences is retrieved. In a preferred embodiment full audio programs are retrieved for each desired news information data. In an alternative embodiment, if the base unit maintains the various user preferences, then the base unit need not transmit the identification information, but rather uses the identification information to determine the desired news information data topics, and requests the specific data necessary to generate the user's desired audio program. In this case, the requested full audio programs (or full, summary and headline audio programs, as will be discussed below) are returned to the base unit for further processing.

After all of the desired full audio programs are retrieved, a determination is made at step 340 whether the audio playback time is greater than the designated time span designated corresponding to the particular identification information. If this inquiry is answered in the affirmative, then at a step 350, certain of the full audio data programs are converted to summary or title data. Preferably the data indicated as being less desirable in the user preferences is converted to a shorter format first. This conversion to shorter format may take place in a number of ways. First, the remote storage device may retrieve a pre-generated shorter audio program (summary or headline data) corresponding to one of the programs to be converted. Alternatively, the full audio program may be simply cut off after a certain amount of audio playback time has been reached. Additionally, sophisticated summarizing software may be employed to generate a summary audio data. While this last method may be the most complicated, it offers the most flexibility. For example, if it is determined that the complete audio program is 5 minutes too long, the remote storage unit can indicate any number of audio program data that are to be shortened. Intelligent software may be used to determine which audio data programs are most susceptible to summarizing and summarize each indicated document an appropriate amount to generate an audio program of the appropriate length. In this manner, important data will not be missed and cohesive summary audio programs can be provided. After shortening, control passes back to step 340. If it is determined that the audio data is still too long, the procedure of step 350 is once again repeated.

Once it is determined at step 340 that the audio playback data is not longer than the designated time span, control passes to step 360 where the audio data is forwarded to the base unit. Step 370 follows and the audio data is in turn forwarded to the remote device. A user can then listen to the audio data during a desired, pre-selected time span. Of course if the base unit had been performing the computing and has received requested data from the remote storage device, then after a determination that the audio data is not longer than the designated time span, the only remaining step is to transfer the complete audio program to the remote device.

If at step 340 it is determined that the audio playback data is substantially shorter than the designated time span, additional audio data information not included in designated topics, but that may nonetheless be interesting to the user may be downloaded. This additional information is preferably selected based upon the various selected user preferences. Furthermore, certain information may be included regardless of user preferences. For example, emergency headlines might be included, as appropriate to all users regardless of preferences. Thus, a feature exists to override the user preferences in certain situations. Additionally, while audio news program data has been described, other data might also be included, such as commercials, advertisements or the like. The subjects of these commercials or advertisements are similarly preferably selected based upon the designated user preferences.

While a three component system has been described, various two component systems could be employed using similar methods. For example, if the remote storage device is to perform all calculations and generate the complete audio program, this program need not be transferred first to the base unit and then to the remote unit. Rather, this complete audio program could be transferred directly to the remote unit (thus requiring a direct connection between the remote unit and the remote storage device for identification and other purposes). The data may be preloaded to the remote device and stored in a memory unit thereof, or may be provided to the remote unit as streaming audio in real time, via a proprietary computer network, or via digital or analog radio. Thus, in addition to the embodiments noted above, a user may obtain the downloaded personal news program in his or her car or other radio receives, thereby reducing the need for storage in the remote unit.

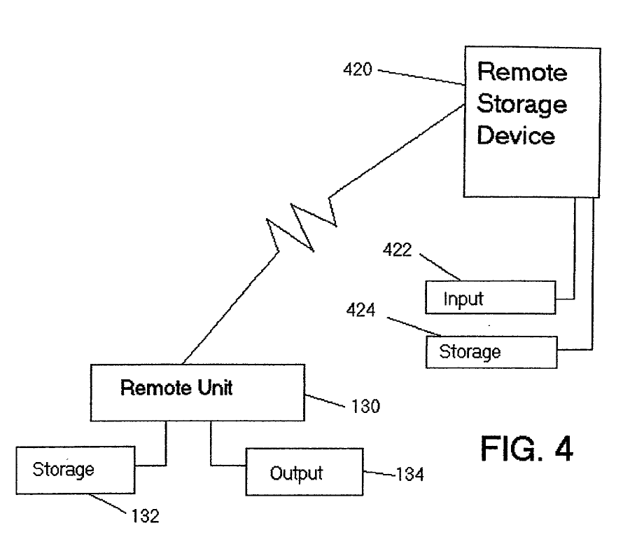

Such a configuration is shown in FIG. 4 where a direct connection is shown between remote storage device 420 and remote unit 130. As is shown, while remote unit 130 is the same as in the first embodiment, remote storage device 420 may include additional features, such as an input 422 and an additional storage 424. Thus, in this embodiment, selection and preference data may be entered in two ways. First, in a manner similar to that in the first embodiment, such preference and time span designation data may be entered into remote unit 130. This data is then transferred to remote storage device 420 and stored in storage 424 for later use. Alternatively, remote storage device 420 may receive this user preference and time span designation data directly via input 422. In this case, remote storage device 420 is preferably accessible via the Internet or other remote access network (similar to any access or communication methods noted above) so that the user may visit a predesignated website to enter the desired information. After entered, identification of the remote unit and correspondence to a set of entered preference and time span data is performed in a manner similar to that of the first embodiment.

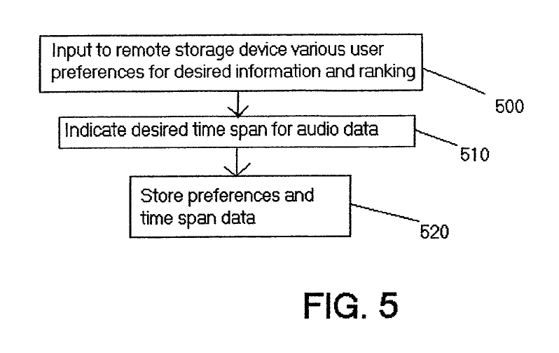

Thus, FIG. 5 depicts a sequence used to allow a user to designate various preferences in accordance with this additional embodiment of the invention. At step 500 a user inputs to the remote storage device various user preferences for desired information, and ranks these various preferences. This ranking may comprise designating most to least desirable information or simply indicating high or low priority for one or more of the desired information. Either way, based upon the user input, user preference data is generated indicating a relative preference for various types of desired data. After such preference input, control passes to step 510 where a user inputs a desired time span he or she wishes the output of the audio data to cover. This time span might correspond to a typical commute time for the user, but may correspond to any desired time span. Control then passes to step 530 where the input preference and time span data are stored at the remote storage unit in a designated storage area. This data is thus associated with a particular user and is stored in an appropriate database.

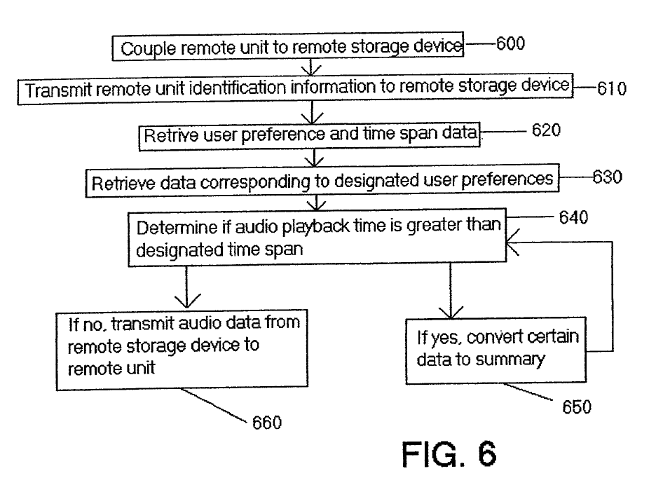

FIG. 6 depicts a sequence used when the audio data is to be downloaded to remote unit 130 in accordance with this embodiment of the invention. As is shown in FIG. 6, a remote unit is first coupled to the remote storage device at a step 600. This coupling is preferably performed via a wired connection such as through a direct serial connection, a bus such as a universal serial bus, a 1394 “firewire” bus or via any other network structure. This connection may further be performed via a wireless connection or via the Internet or other wide area network connection. Upon this connection the remote unit is identified to the remote storage device through various handshake protocols, as is well known in the art. Of course, rather than automatically identifying the remote unit to the remote storage device, the user could enter a desired identification code so that the user preference could be used to retrieve data for a plurality of devices.

After the remote unit has been identified to the remote storage device, an information request is sent from the remote unit to the remote storage device, as is shown at step 610. This information request is then received by the remote storage device, and is used in accordance with the identification information to retrieve the user preferences and time span data associated with the coupled remote unit at a step 620. Based upon these user preferences, in step 630 various news information data corresponding to these user preferences is retrieved. In a preferred embodiment full audio programs are retrieved for each desired news information data. In an alternative embodiment, if the remote unit maintains the various user preferences and is to generate the user's audio program, then the remote unit need not transmit the identification information to the remote storage device, but rather uses the identification information to determine the desired news information data topics, and requests the specific data necessary to generate the user's desired audio program from the remote storage device. In this case, the requested full audio programs (or full, summary and headline audio programs, as will be discussed below) are returned to the remote unit for further processing.

After all of the desired full audio programs are retrieved, a determination is made at step 640 whether the audio playback time is greater than the designated time span designated corresponding to the particular identification information. If this inquiry is answered in the affirmative, then at a step 650, certain of the full audio data programs are converted to summary or title data. Preferably the data indicated as being less desirable in the user preferences is converted to a shorter format first. This conversion to shorter format may take place in a number of ways. First, the remote storage device may retrieve a pre-generated shorter audio program (summary or headline data) corresponding to one of the programs to be converted. Alternatively, the full audio program may be simply cut off after a certain amount of audio playback time has been reached. Additionally, sophisticated summarizing software may be employed to generate a summary audio data. While this last method may be the most complicated, it offers the most flexibility. For example, if it is determined that the complete audio program is 5 minutes too long, the remote storage unit can indicate any number of audio program data that are to be shortened. Intelligent software may be used to determine which audio data programs are most susceptible to summarizing and summarize each indicated document an appropriate amount to generate an audio program of the appropriate length. In this manner, important data will not be missed and cohesive summary audio programs can be provided. After shortening, control passes back to step 640. If it is determined that the audio data is still too long, the procedure of step 650 is once again repeated.

Once it is determined at step 640 that the audio playback data is not longer than the designated time span, control passes to step 660 where the audio data is forwarded to the remote device. A user can then listen to the audio data during a desired, pre-selected time span. Of course if the remote unit had been performing the computing and has received requested data from the remote storage device, then after a determination that the audio data is not longer than the designated time span, the only remaining step is to output the complete audio program from the remote device when requested to be listened to by the user.

If at step 640 it is determined that the audio playback data is substantially shorter than the designated time span, additional audio data information not included in designated topics, but that may nonetheless be interesting to the user may be downloaded. This additional information is preferably selected based upon the various selected user preferences. Furthermore, certain information may be included regardless of user preferences. For example, emergency headlines might be included, as appropriate to all users regardless of preferences. Thus, a feature exists to override the user preferences in certain situations. Additionally, while audio news program data has been described, other data might also be included, such as commercials, advertisements or the like. The subjects of these commercials or advertisements are similarly preferably selected based upon the designated user preferences.

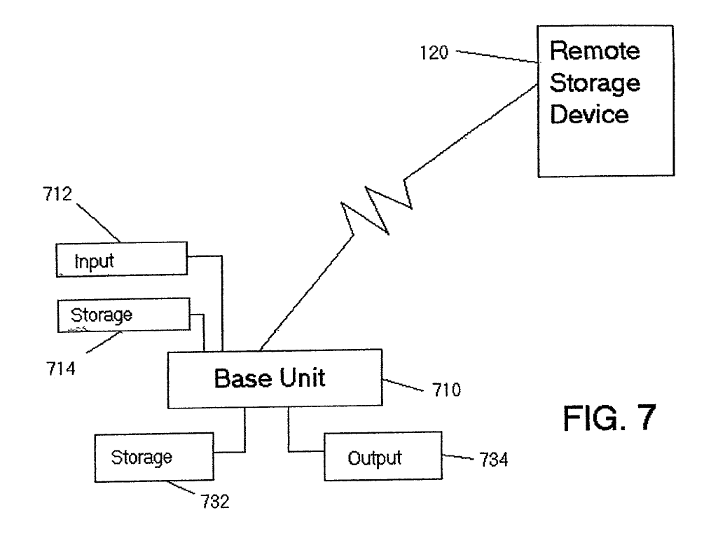

Referring next to FIGS. 7-9, an additional embodiment of the invention will be described. Referring first to FIG. 7, a data download system constructed in accordance with the invention is shown. The data download system comprises a base unit 710 and a remote storage device 120. Base unit 710 is preferably in contact with remote storage device 120 via the Internet or other computer network (such as a wide area network, local area network, Intranet, direct phone connection, wireless connection or the like).

Base unit 710 is preferably provided as a personal computer but may comprise an appropriate computing device. Base unit 710 further comprises an input unit 712 to receive various input preferences from a user and a storage device 714 for storing various received data. Base unit 710 further comprises a CPU, display device and the like (not shown) common to a personal computer or other computing device, but may also comprise a less conventional receiver, such as a digital radio receiver, cellular telephone or the like The remote storage device comprises a storage memory, and also preferably comprises additional hardware common to a server device or personal computer (not shown). Base unit 710 further comprises a storage unit 732 for storing various received data and an output port 734 for outputting stored data. Output port 734 may allow for the coupling of an audio transducer, such as included with headphones or speakers, to base unit 710 so that output stored data is converted to audio data. Alternatively, the stored data might be output in electronic form and acted upon at a further remote location.

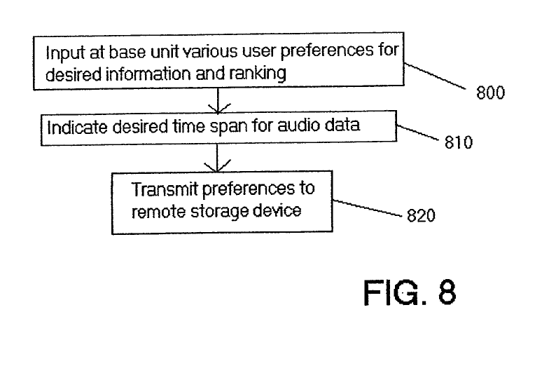

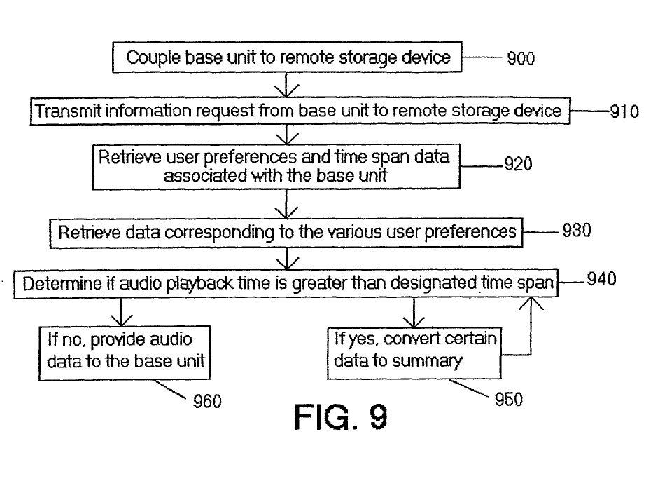

Referring next to FIGS. 8 and 9 in addition to FIG. 7, this embodiment of the invention will now be described. FIG. 8 depicts a sequence used to allow a user to designate various preferences. At a step 800 a user inputs various user preferences for desired information to the base unit, and ranks these various preferences. This ranking may comprise designating most to least desirable information or simply indicating high or low priority for one or more of the desired information. Either way, based upon the user input, user preference data is generated indicating a relative preference for various types of desired data. After such preference input, control passes to step 810 where a user inputs a desired time span he or she wishes the output of the audio data to cover. This time span might correspond to a typical commute time for the user, but may correspond to any desired time span. Control then passes to step 830 where the input preference and time span data are transferred to the remote storage unit where this data is associated with a particular user and is stored in an appropriate database.

FIG. 9 depicts a sequence used when the audio data is to be downloaded to base unit 710. As is shown in FIG. 9, the base unit is first coupled to the remote storage device in step 900. This coupling is preferably performed via a wired connection such as through a direct serial connection, a bus such as a universal serial bus, a 1394 “firewire” bus or via any other network structure. This connection may further be performed via a wireless connection or via the Internet or other wide area network connection. Upon this connection the base unit is identified to the remote storage device through various handshake protocols, as is well known in the art. Of course, rather than automatically identifying the base unit to the remote storage device, the user could enter a desired identification code so that the user preference could be used to retrieve data for a plurality of devices.

After the base unit has been identified to the remote storage device, this identification information accompanies an information request sent from the base unit to the remote storage device, as is shown at step 910. This identification information is then received by the remote storage device, and is used thereby to retrieve the user preferences and time span data associated with the transmitted identification information in step 920. Based upon these user preferences, in step 930 various news information data corresponding to these user preferences is retrieved. In a preferred embodiment full audio programs are retrieved for each desired news information data. In an alternative embodiment, if the base unit maintains the various user preferences, then the base unit need not transmit the identification information, but rather uses the identification information to determine the desired news information data topics, and requests the specific data necessary to generate the user's desired audio program. In this case, the requested full audio programs (or full, summary and headline audio programs, as will be discussed below) are returned to the base unit for further processing.

After all of the desired full audio programs are retrieved, a determination is made at step 940 whether the audio playback time is greater than the designated time span designated corresponding to the particular identification information. If this inquiry is answered in the affirmative, then at a step 950, certain of the full audio data programs are converted to summary or title data. Preferably the data indicated as being less desirable in the user preferences is converted to a shorter format first. This conversion to shorter format may take place in a number of ways. First, the remote storage device may retrieve a pre-generated shorter audio program (summary or headline data) corresponding to one of the programs to be converted. Alternatively, the full audio program may be simply cut off after a certain amount of audio playback time has been reached. Additionally, sophisticated summarizing software may be employed to generate a summary audio data. While this last method may be the most complicated, it offers the most flexibility. For example, if it is determined that the complete audio program is 5 minutes too long, the remote storage unit can indicate any number of audio program data that are to be shortened. Intelligent software may be used to determine which audio data programs are most susceptible to summarizing and summarize each indicated document an appropriate amount to generate an audio program of the appropriate length. In this manner, important data will not be missed and cohesive summary audio programs can be provided. After shortening, control passes back to step 940. If it is determined that the audio data is still too long, the procedure of step 950 is once again repeated.

Once it is determined at step 940 that the audio playback data is not longer than the designated time span, control passes to step 960 where the audio data is forwarded to the base unit. A user can then listen to the audio data during a desired, pre-selected time span. Of course if the base unit had been performing the computing and has received requested data from the remote storage device, then after a determination that the audio data is not longer than the designated time span, the only remaining step is to output the complete audio program from the base unit.

If at step 940 it is determined that the audio playback data is substantially shorter than the designated time span, additional audio data information not included in designated topics, but that may nonetheless be interesting to the user may be downloaded. This additional information is preferably selected based upon the various selected user preferences. Furthermore, certain information may be included regardless of user preferences. For example, emergency headlines might be included, as appropriate to all users regardless of preferences. Thus, a feature exists to override the user preferences in certain situations. Additionally, while audio news program data has been described, other data might also be included, such as commercials, advertisements or the like. The subjects of these commercials or advertisements are similarly preferably selected based upon the designated user preferences.

Therefore, as noted by the various embodiments, no remote device is required. The audio data may be played back to the user directly from the base unit. However, the base unit is not necessarily a stationary computer, and may also comprise a portable device. Furthermore, rather than transferring the data directly to the remote device, the complete audio program may be transferred to a removable storage unit at the base unit or remote storage device, such as a compact disc, compact or flash memory, or the like. In this manner, the user is able to playback the complete audio program in any desired audio playback device, such as a car radio or the like.

Once a particular complete audio program has been downloaded to a particular base unit or remote device, a record of the date and time of the download, as well as the particulars of what information was downloaded is preserved. This is primarily so that upon a subsequent request for information, duplicates of the audio program are not provided. For example, if a user requests information to be downloaded for both a morning and evening commute, different audio data is provided. Obviously, newly generated data from the morning to the evening is provided. However, certain information that may have been available for the morning, but was unable to fit in the complete audio program in the morning may be provided or the evening commute if there is less new information to fill the audio program.

Such a situation might arise as follows. If a user does not request audio data for a few days, the amount of information available for the designated preferences is likely to be quite large. Thus certain information will likely not be included in a particular complete audio program. Therefore, on a subsequent request for audio data, this additional information can be included. Furthermore, in accordance with the invention, if the user is provided with particular summary or headline data, the user can indicate that on a subsequent request for information, he or she would like to receive the full audio text for that particular story. Thus, if a user has not requested data for some time, or a large amount of new information is available, the user is likely to receive a higher percentage of summary and headline data. This request feature thus insures that the user can request complete audio information for one or more particular stories. This data is preferably provided during the next data request, but may be provided immediately if a direct connection is present between the remote unit and remote storage unit.

Additionally, while it is difficult to determine before the audio data is actually selected what the length will be, in accordance with an additional aspect of the invention, as a user enters various designations for topics of interest, the device receiving the input may calculate an average amount of the audio program that is likely to be provided in summary format. Thus, based upon an average or projected amount of audio data for each particular selected topic, a pre-calculation of the audio program length and possible summarization requirements might be provided. While a very rough estimate because the news for any particular topic is different each day, based upon the input time span, a user might be given an idea if her or she has too many topics and will only receive primarily summary information, or has plenty of room left. Of course, the only true way to determine if the mix of full, summary and title data is to listen to a broadcast, and thereafter delete some of the less important topics if too many of the important topics are provided in summary of title form because of a lack of time.

An exemplary method for determining the audio programs and their length and structure to be provided to a user will now be discussed. Of course, any algorithm that results in a differentiation between various selected audio programs so that certain of them may be provided as summary data or title data as necessary may be employed. Thus, while the specific comparisons and choices listed herein may be employed in the preferred embodiment, other comparisons and choices may be employed.

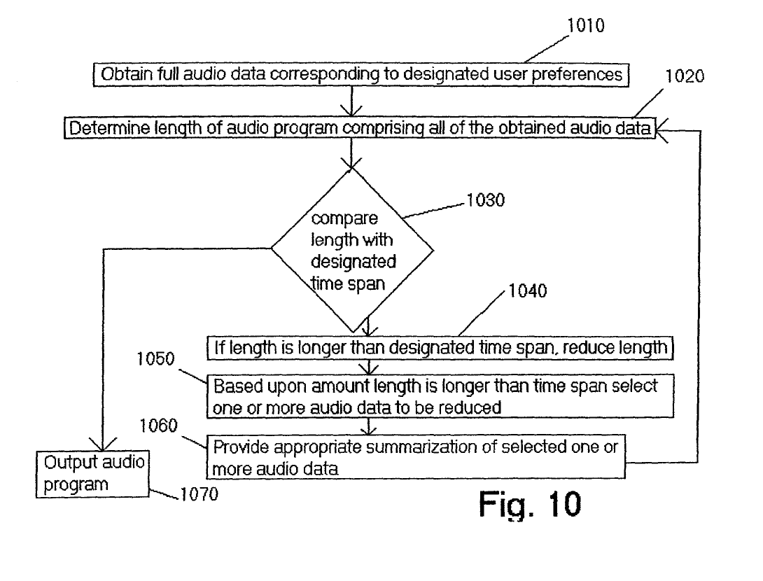

Therefore, referring next to FIG. 10, a method for determining and reducing the time necessary for an audio program to be output to correspond to a user-designated time span is shown. This method may be employed with any of the embodiments of the invention described above, or any other system configurations. In FIG. 10, at a step 1010, full audio data corresponding to selected audio programs based upon the predesignated user preferences are obtained. Then, at a step 1020 the length of the audio program including all of the obtained audio data is determined. As noted above, this total length may also include advertisements, emergency headlines or information or the like. Next, this determined length is compared with the user-designated time span at a step 1030.

If the inquiry at step 1030 is answered in the affirmative, and it is determined that the length of the audio program is greater than the predesignated time span, then control passes to step 1040 where the length of the audio program is reduced. In this embodiment, this reduction in time of the audio program is performed in accordance with the procedure outlined in steps 1050 and 1060. At step 1050, based upon the amount the audio program is longer than the designated time span, one or more audio data are selected to be reduced in length. This selection process is preferably carried out employing a sophisticated summarizing system that can determine which of the plurality of audio programs are easiest to edit without losing the meaning of the document. Of course, the least important documents are preferably reduced in length the most. Therefore, at step 1060 an appropriate summarization of the one or more selected audio data are provided. This summarization, in the case of one or more documents, might result in only a title being provided. After summaries are provided control returns to step 1020 where the length of the audio program is once again determined. Because of the sophisticated summarizing system employed, the length should be less that the predesignated time span, as determined at inquiry 1030. If it is not, steps 1040-1060 are repeated. However, if it is determined that the length of the audio program is less than the predesignated time span, the audio program is output at step 1070.

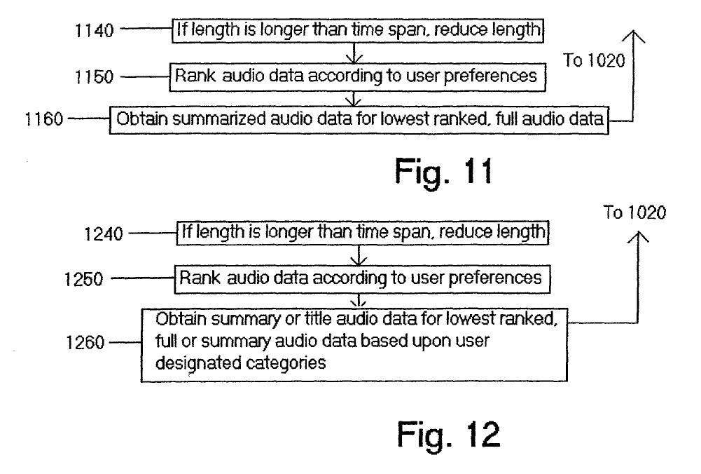

While this procedure disclosed in FIG. 10 may be employed in the invention to reduce the length of the audio program, any such appropriate procedure. FIGS. 11-13 depict, by way of example only, a number of these procedures.

As is shown in FIG. 11, If the inquiry at step 1030 of FIG. 10 is answered in the affirmative, and it is determined that the length of the audio program is greater than the predesignated time span, then control passes to step 1140 where the length of the audio program is reduced. In this embodiment, this reduction in time of the audio program is performed in accordance with the procedure outlined in steps 1150 and 1160. At step 1150, the audio data is ranked according to the designated user preferences. Then, at step 1160 summary data for the lowest ranked audio data that is still in full format is obtained and substituted for the corresponding full audio data. After the summary is provided control returns to step 1020 where the length of the audio program is once again determined. The inquiry at step 1030, and the steps of 1140-1160 are preformed until the inquiry at step 1030 is answered in the negative and control passes to step 1070 from step is 1030.

Referring next to FIG. 12, if the inquiry at step 1030 is answered in the affirmative, and it is determined that the length of the audio program is greater than the predesignated time span, then control passes to step 1240 where the length of the audio program is reduced. In this embodiment, this reduction in time of the audio program is performed in accordance with the procedure outlined in steps 1250 and 1260. At step 1250, the audio data is ranked according to the designated user preferences. Then, at step 1260 summary data or title data for the lowest ranked audio data that is still in full or summary format is obtained and substituted for the corresponding full or summary audio data. After the summary or title data is provided control returns to step 1020 where the length of the audio program is once again determined. The inquiry at step 1030, and the steps of 1240-1260 are preformed until the inquiry at step 1030 is answered in the negative and control passes to step 1070 from step 1030.

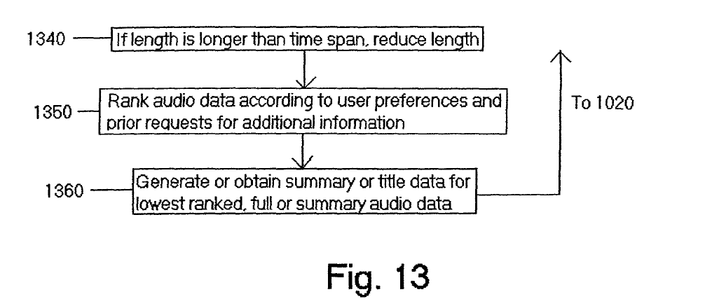

Referring next to FIG. 13, if the inquiry at step 1030 is answered in the affirmative, and it is determined that the length of the audio program is greater than the predesignated time span, then control passes to step 1340 where the length of the audio program is reduced. In this embodiment, this reduction in time of the audio program is performed in accordance with the procedure outlined in steps 1350 and 1360. At step 1350, the audio data is ranked according to the designated user preferences and any prior requests for a user for additional information regarding a audio program that had been shortened to a summary of title format. Then, at step 1360 summary data or title data for the lowest ranked audio data that is still in full or summary format is obtained and substituted for the corresponding full or summary audio data. After the summary or title data is provided control returns to step 1020 where the length of the audio program is once again determined. The inquiry at step 1030, and the steps of 1340-1360 are preformed until the inquiry at step 1030 is answered in the negative and control passes to step 1070 from step 1030.

It will thus be seen that the objects set forth above, among those made apparent from the preceding description, are efficiently attained and, because certain changes may be made in carrying out the above method and in the construction(s) set forth without departing from the spirit and scope of the invention, it is intended that all matter contained in the above description and shown in the accompanying drawings shall be interpreted as illustrative and not in a limiting sense.

It is also to be understood that the following claims are intended to cover all of the generic and specific features of the invention herein described and all statements of the scope of the invention which, as a matter of language, might be said to fall therebetween.

What is claimed:

1. A method for downloading audio data; comprising the steps of:
providing user preference data indicating one or more topics of interest to a user, and a relative ranking between these topics;
providing user designated time span data indicative of a desired time for listening to an audio program;
forwarding said user preference data and said user designated time span data to a storage device;
retrieving a plurality of audio data corresponding to said user preference data;
determining a length of time required to playback said audio data;
determining whether said length of time required to playback said audio data is longer than said user designated time span;
reducing the length of at least one of said plurality of audio data if it is determined that said length of time required to playback said audio data is longer than said user designated time span; and
outputting said audio data including said one of said plurality of audio data reduced in length.

2. The method of claim 1, wherein the determination of said length of time required to playback said audio data, the determination of whether said length of time required to playback said audio data is linger than said user designated time span, and the reducing the length of at least one of said plurality of audio data are repeated, each time reducing the length of a different one of said plurality of audio data until it is determined that said length of time required to playback said audio data is not longer than said user designated time span.

3. The method of claim 1, wherein said audio data comprises news programs.

4. The method of claim 1, wherein at least one of said plurality of said audio data comprises an advertisement.

5. The method of claim 1, wherein the length of said at least one of said audio data is reduced by substituting a summary audio data for said audio data.

6. The method of claim 1, wherein the length of said at least one of said audio data is reduced by substituting a title audio data for said audio data.

7. The method of claim 1 wherein the determination of said length of time required to playback said audio data, the determination of whether said length of time required to playback said audio data is linger than said user designated time span, and the reducing the length of at least one of said plurality of audio data are repeated, each time reducing the length of one of said plurality of audio data until it is determined that said length of time required to playback said audio data is not longer than said user designated time span.

8. The method of claim 7, wherein the length of said at least one of said audio data is reduced by substituting a summary audio data for said audio data.

9. The method of claim 8, wherein the length of said at least one of said audio data is reduced by substituting a title audio data for said summary audio data.

10. The method of claim 7, wherein the length of said at least one of said audio data is reduced by substituting a title audio data for said audio data.

11. The method of claim 1, wherein said relative ranking between topics includes placing the topics in a continuous order from most to least, or least to most desirable.

12. The method of claim 1, wherein said relative ranking between topics includes placing each of the topics in one of a plurality of categories, the categories indicating a relative preference between the topics contained therein

13. The method of claim 1 wherein said relative ranking between topics includes indicating whether an audio program corresponding to each topic is eligible to be reduced in length.

14. The method of claim 1, wherein the length of at least one of said plurality of audio data is reduced according to the steps of:
determining which of a plurality of audio clips are eligible to be reduced in length;
analyzing all of said eligible audio clips to determine which of said plurality of eligible audio clips are most susceptible to reduction in length without changing the meaning thereof, and
reducing the length of one or more of said audio clips determined to be most susceptible to reduction in length without changing the meaning thereof.

15. The method of claim 14, wherein the reduction in total length of said one or more of said audio clips is equal to or greater than said length of time required to playback said audio data is longer than said user designated time span.

16. A method for downloading audio data; comprising the steps of:
retrieving a plurality of audio data;
determining a length of time required to playback said audio data;
determining whether said length of time required to playback said audio data is longer than a designated time span; and
reducing the length of at least one of said plurality of audio data if it is determined that said length of time required to playback said audio data is longer than said designated time span.

17. The method of claim 16, wherein said plurality of audio data is selected in accordance with one or more user preferences.

18. The method of claim 16, wherein said designated time span is designated by a user.

19. A base unit for downloading audio data; comprising:
an input port for receiving user preference data and user designated time span data;
a transmission device for forwarding said user preference data and said user designated time span data to a remote storage unit;
a receiver for receiving audio data from said remote storage device selected and in accordance with said user preference data and said user designated time span data; and
an output port for outputting said received audio data.

20. The base unit of claim 19, wherein said received audio data is output to a remote device.
